(19) United States
(12) Patent Application Publication
(10) Pub. No.: US 2016/0186774 A1
(43) Pub. Date: Jun. 30, 2016

(54) PROCESS OF PRODUCING A THERMOPLASTIC-FIBER COMPOSITE AND FAN BLADES FORMED THEREFROM

(71) Applicant: GENERAL ELECTRIC COMPANY, Schenectady, NY (US)

(72) Inventors: Paul Stephen MANICKE, West Chester, OH (US); Douglas Duane WARD, West Chester, OH (US); Gregory Carl GEMEINHARDT, Cincinnati, OH (US)

(21) Appl. No.: 14/909,220

(22) PCT Filed: Jul. 28, 2014
(86) PCT No.: PCT/US2014/048428

§ 371 Date: Feb. 1, 2016

Related U.S. Application Data
(60) Provisional application No. 61/860,990, filed on Aug. 1, 2013.

(51) Int. Cl. F04D 29/38; B29C 70/30; F04D 29/32

(52) U.S. Cl. CPC F04D 29/388; F04D 29/325; B29C 70/30; B29L 2031/08

(57) ABSTRACT

A process for fabricating a thermoplastic-fiber composite includes heating a thermoplastic resin to a liquid state, unidirectionally orienting fibers, impregnating the fibers with the thermoplastic resin in the liquid state to produce composite laminae, and performing an automated machine lay-up process to produce a composite laminate comprising a plurality of the composite laminae.

### BACKGROUND OF THE INVENTION

Embodiments of the present invention relate to composite materials, and more particularly to processes for fabricating composite materials that comprise a reinforcement fabric infiltrated with a polymeric resin.

A key component of a high-bypass gas turbine engine is the fan section and its blades. The fan blades are the distinctive feature of the engine when viewed from the front (looking aft), and are the first component of the engine to contact incoming air. As such, fan blades must be capable of performing at the speeds, altitudes and inlet temperatures demanded of high-bypass aircraft engines. In addition, fan blades must be capable of mitigating a variety of adverse environmental effects, while withstanding and operating through bird impacts and other foreign object damage (FOD) at high speeds. As a result, an operational requirement of a fan blade is a high degree of impact resistance.

Due to additional requirements of aircraft engines, fan blades are also relatively lightweight, durable, and tough. Significant research and development has been invested in improving blade operation and construction so as to improve engine performance by having lower rotating mass, greater damage tolerance, greater vibratory damping, and increased aerodynamic efficiency. When improving blade toughness, generally the goal is to improve blade durability and impact strength so that the blade can be reduced in thickness while maintaining or improving its overall resistance to fracture and impact damage. Lighter blades lead to improved aerodynamic efficiency and reduce the weight, cost, and efficiency of the engine as a whole.

Recently, much progress has been made in the integration and application of composite materials in aircraft components, including engine fan blades. Fan blades made from polymeric matrix composite (PMC) materials include two main components: a polymer resin material and a fiber reinforcement material impregnated by the resin to provide strength and structure to the composite. Thermoset epoxy PMC materials have also been considered, such as epoxy laminates reinforced with carbon (graphite) fibers or fabrics, as they offer advantages including the ability to meet aerodynamic criteria and reduce weight, which promote engine efficiency and improve specific fuel consumption (SFC).

Composite fabrication involves not only impregnation, but also a lay-up process. During the lay-up process, a prepreg comprising a resin-impregnated reinforcement material is cut and drawn into plies or sheets of material. The plies may then be cut, stitched or pressed into layers to produce a resin-impregnated laminate composite structure, which can be shaped according to the operation and purpose of the composite.

Although fan blades manufactured with thermoset epoxy PMC provide impact resistance characteristics and can produce thin blades, improvements are needed to continue engine performance gains.

### BRIEF DESCRIPTION OF THE INVENTION

Embodiments of the present invention provide processes suitable for fabricating thermoplastic resin/fiber composites, particular but nonlimiting examples of which include aircraft engine fan blade airfoils including fan blades of high-bypass gas turbine engines.

According to a first aspect of the invention, a process for fabricating a thermoplastic-fiber composite includes heating a thermoplastic resin to a liquid state, unidirectionally orienting fibers, optionally coating the fibers to improve composite damage tolerance, impregnating the fibers with the thermoplastic resin in the liquid state to produce composite laminae, and performing an machine lay-up process to produce a composite laminate comprising a plurality of the composite laminae.

Other aspects of the invention include fan blade airfoils produced by a process comprising the steps described above.

Other aspects and advantages of this invention will be better appreciated from the following detailed description.

### BRIEF DESCRIPTION OF THE DRAWINGS

FIG. 1 represents a fan blade of a type that may be fabricated with a polymer matrix composite material.

### DETAILED DESCRIPTION OF THE INVENTION

Embodiments of the present invention relate to processes for the fabrication of thermoplastic resin/fiber composites for use in aircraft engine fan blade airfoils, including fan blades of high-bypass gas turbine engines.

A difference between thermoset and thermoplastic resins is that thermoset resins exist as a liquid at room temperature, whereas thermoplastics exist as a solid at room temperature. Thermoplastics provide two distinct advantages over thermosets: they have a greater impact resistance to comparable thermoset composites, and they are reformable, allowing them to be reused or repaired more easily than comparable thermosets. Their greater impact resistance makes them desirable for use in fan blade fabrication. However, there are complications to using thermoplastics in reinforced composite fabrication. Because thermoplastics are solid at room temperature they require reheat to make them formable for manufacture. Typically, this process is more time-consuming and possibly cost-prohibitive than a similar impregnating process involving a comparable thermoset resin.

Briefly, an embodiment of such a process involves orienting unidirectional pre-impregnation (prepreg) of a reinforcement material with a thermoplastic resin to produce composite plies. A nonlimiting example is carbon (graphite) fibers as a unidirectional reinforcement material that is impregnated with the thermoplastic resin, for example, poly ether ether ketone (PEEK), though other thermoplastics could be used, nonlimiting examples of which include polyetherketoneketone (PEKK), polyphenylene sulfide (PPS), polyamideimide (PAI), and polyetherimides (PEI). A decoupling agent may be applied as a coating on the reinforcement material to further improve composite damage tolerance of the resulting fan blade. Another step of the process is machine lay-up, in which the composite plies are cut and removed from the bulk. This machine process is an improvement over hand lay-up methods. A consolidation process or autoclave cure step is then performed, in which the composite plies are shaped and solidified.

The unidirectional prepreg process constructs a composite material from the thermoplastic resin and reinforcement material. The thermoplastic resin is heated to a liquid state, then the reinforcement material is impregnated with the resin to form a reinforced polymer matrix. As noted above, the reinforcement material comprises unidirectional (fibers), more particularly continuous carbon (graphite) fibers and glass fibers. As used herein, continuous refers to reinforcement (fiber) material made up of fibers or fiber bundles (tows) that are sufficiently long to be capable of being oriented to have a specified orientation (unidirectional) within a matrix material of a composite, for example(but not limiting), parallel to the load direction on the composite, in contrast to discontinuous fiber reinforcement materials made up of shorter fibers that are typically randomly dispersed in a matrix material of a composite. In an embodiment of the present invention, the fibers are suitable for being unidirectionally impregnated, such that all the impregnated fibers are and remain orientated substantially parallel to each other. This process yields a composite material that exhibits desirable structural and mechanical properties.

The decoupling process, as embodied by the invention, involves the application of a coating to the unidirectional reinforcement fibers. The coating may be applied before the prepreg process and enables the fibers to better interface as a reinforcement material with the thermoplastic matrix. The result of this coating is a distributed damage mechanism in the composite matrix to further improve composite toughness during impact damage.

The machine lay-up process, as embodied by the invention, involves cutting and drawing the composite material into plies and shaped into laminae, which are then stacked and shaped to produce a laminate. As used herein, the term laminae refer to complete plies, ply segements, and portions of plies in shapes and strips. The process may also involve ultrasonically-assisted stitching processes, in which reinforcement fibers may be inserted through multiple ply layers, improving the qualities of the laminate as a whole. The machine lay-up process saves labor cost when considered in contrast to conventional lay-up processes that use manual skill and labor to cut the plies and construct and shape the laminae.

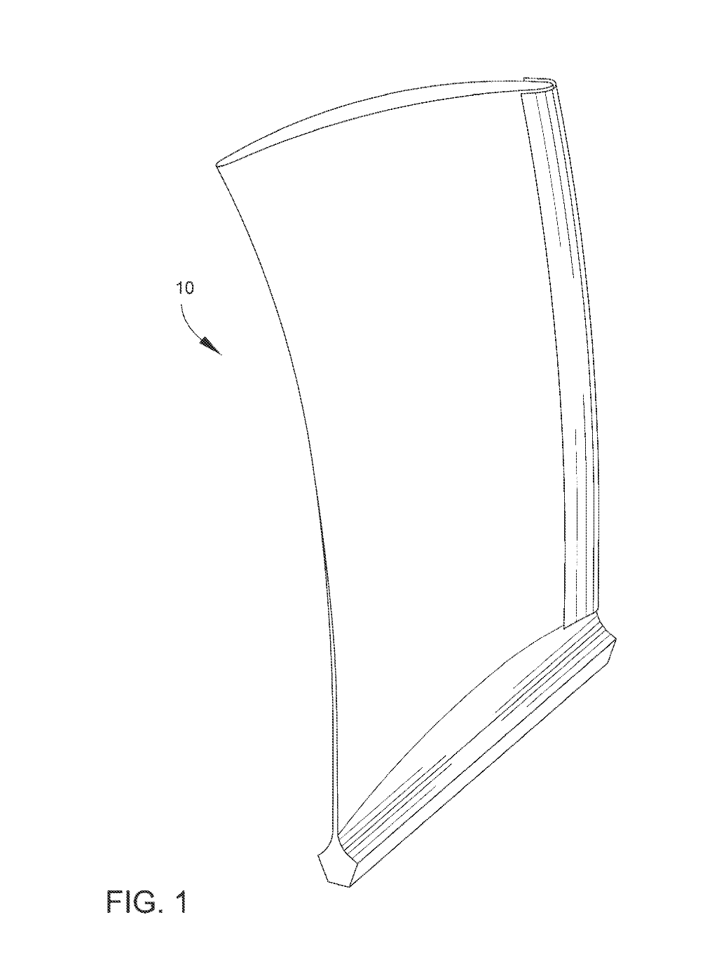

Finally, the process may use an in-situ consolidating process or autoclave cure to shape and cool the laminate to yield a composite article. A consolidating process more particularly uses consolidating forces to press the laminate and its plies/laminae into the desired shape and is generally a part of the lay-up process. An autoclave cure places a laminate in a high-pressure device to shape the final composite. Suitable autoclave temperatures include temperatures from about 600° F. to about 840° F., preferably from about 680° F. to about 760 ° F., which is higher than typical thermoset autoclaving temperatures. One composite article would be a fan blade 10 as depicted in FIG. 1.

While the invention has been described in terms of specific embodiments, it is apparent that other forms could be adopted by one skilled in the art. For example, composite components other than fan blades could be produced, processing parameters could be modified, and appropriate materials could be substituted for those noted. Accordingly, it should be understood that the invention is not limited to the specific disclosed embodiments. It should also be understood that the phraseology and terminology employed above are for the purpose of disclosing the invention, and do not necessarily serve as limitations to the scope of the invention. Finally, while the appended claims recite certain aspects believed to be associated with the invention, they do not necessarily serve as limitations to the scope of the invention.

What is claimed is:

1. A process for fabricating a thermoplastic-fiber composite, the process comprising:
heating a thermoplastic resin to a liquid state;
unidirectionally orienting reinforcement material;
impregnating the reinforcement material with the thermoplastic resin in the liquid state to produce composite laminae; and
performing a machine lay-up process to produce a composite laminate comprising a plurality of the composite laminae.

2. The process according to claim 1, further comprising coating the reinforcement material with a decoupling agent to improve composite damage tolerance.

3. The process according to claim 1, wherein the machine lay-up process comprises an in-situ consolidation process shaping the composite laminate.

4. The process according to claim 1, further comprising shaping the composite laminate using an autoclave cure process.

5. The process according to claim 1, wherein the thermoplastic resin comprises polyether ether ketone.

6. The process according to claim 1, wherein the reinforcement material comprise fibers.

7. The process according to claim 1, wherein the reinforcement material comprise continuous glass fibers.

8. The process according to claim 1, wherein the reinforcement material comprise continuous carbon fibers.

9. The process according to claim 1, wherein the machine lay-up process comprises ultrasonically aided stitching in which additional reinforcement material is driven through multiple of the composite laminae to strengthen the composite laminate.

10. A gas turbine engine thermoplastic-fiber composite fan blade with unidirectionally oriented reinforcement material impregnated with a thermoplastic resin formed by the process comprising the steps of:
heating a thermoplastic resin to a liquid state;
unidirectionally orienting reinforcement material;
impregnating the reinforcement material with the thermoplastic resin in the liquid state to produce composite laminae; and
performing a machine lay-up process to produce a composite laminate comprising a plurality of the composite laminae.

11. A gas turbine engine thermoplastic-fiber composite fan blade with unidirectionally oriented reinforcement material coated with a decoupling agent and impregnated with a thermoplastic resin formed by the process comprising the steps of:
heating a thermoplastic resin to a liquid state;
unidirectionally orienting reinforcement material;
coating the reinforcement material with a decoupling agent to improve composite damage tolerance;
impregnating the reinforcement material with the thermoplastic resin in the liquid state to produce composite laminae; and
performing a machine lay-up process to produce a composite laminate comprising a plurality of the composite laminae.
